(19) United States
(12) Patent Application Publication
(10) Pub. No.: US 2024/0083746 A1
(43) Pub. Date: Mar. 14, 2024

(54) PROCESS AND PLANT FOR THE PRODUCTION OF HYDROGEN

(71) Applicant: Dino GHINI, Funo di Argelato (BO) (IT)

(72) Inventor: Dino GHINI, Funo di Argelato (BO) (IT)

(21) Appl. No.: 18/263,153

(22) PCT Filed: Jan. 29, 2021
(86) PCT No.: PCT/IB2021/050731

§ 371 Date: Jul. 27, 2023

(51) Int. Cl. C01B 3/08; C25B 11/046

(52) U.S. Cl. CPC C01B 3/08; C25B 11/046

(57) ABSTRACT

A process for the production of hydrogen from an aqueous solution containing hydrochloric acid in dissociated form is provided using an aqueous solution having there being present at least one electrode composed of a metal alloy containing a plurality of metals with different standard reduction potentials therein. The process having the following steps: reduction to hydrogen of the hydronium ions present in the solution, as a result of a flow of electrons generated in the electrode between pairs of metals, from the lower potential metal to the higher potential metal, and extraction of hydrogen thus obtained from the aqueous solution.

### FIELD OF APPLICATION

The present invention relates to a process for the production of hydrogen.

### PRIOR ART

Hydrogen is an important raw material currently used in the chemical and refining industries. There is also a growing interest in the use of hydrogen as fuel, due to its low environmental impact and high energy content.

At present the most common method for large-scale hydrogen production involves the use of hydrocarbons and fossil fuels as starting materials.

The main hydrocarbon conversion process is steam reforming, which consists in the endothermal catalytic transformation of light hydrocarbons (e.g. methane) in the presence of water vapor.

Another process is partial oxidation, in which heavy hydrocarbons (e.g. heavy oil residues from the petrochemical industry) are subjected to heat treatment in the presence of oxygen.

However, the exploitation of hydrocarbons has a very negative impact on the environment, as it involves the emission of large amounts of CO₂ into the atmosphere, resulting in an increase in the heat balance of the earth and the greenhouse effect.

At present a number of technologies for producing hydrogen without simultaneously obtaining CO₂ are being studied.

One of them is water electrolysis. However, this technology has a number of disadvantages due to the limited amount of hydrogen produced and the high costs of using electricity. For these reasons, the water electrolysis process currently covers a negligible amount of the hydrogen produced.

Hydrogen can also be obtained from water through biological production or by thermolysis using heat. However, even these technologies are inefficient for large-scale hydrogen production.

There is therefore a pressing need to develop processes for the production of large quantities of hydrogen which are more energy efficient, capable of reducing CO₂ emissions into the atmosphere and less costly.

### SUMMARY OF THE INVENTION

The invention aims to provide a process for the production of large quantities of hydrogen with a reduced energy consumption and low environmental impact.

This is achieved by means of a process according to claim 1.

According to the process of invention, hydrogen is produced from an aqueous solution containing hydrochloric acid in dissociated form, said solution containing hydronium ions (H₃O⁺), within said aqueous solution there being present at least one electrode composed of a metal alloy containing a plurality of metals with different standard reduction potentials,
the process comprising the following steps:
reduction to hydrogen gas (H₂) of the hydronium ions (H₃O⁺) present in the solution, as a result of a flow of electrons generated in said at least one electrode between pairs of metals, from the lower potential metal to the higher potential metal, and
extraction of the hydrogen gas thus obtained from said aqueous solution.

Said aqueous solution is prepared by introducing hydrochloric acid into water, which dissociate releasing hydronium ions (H₃O⁺) and forming chloride ions (Cl⁻), respectively, according to the following formula:

HCl+H₂O→H₃O⁺+Cl⁻ (1)

The standard reduction potential (E⁰) is the measurement of the tendency of a chemical species to acquire electrons, that is, to be reduced. The higher the value of E, the greater the electronic affinity of the species and therefore its tendency to be reduced. The standard reduction potential E⁰ is defined in relation to the standard hydrogen electrode with potential E⁰=0.00 V, and is measured under standard conditions, i.e. at a temperature of 298 K (25° C.) and at a pressure of 100 kPa (1 bar).

The potential difference between the metals of each pair must be large enough to ensure that this flow of electrons migrates from the metal at lower potential to the metal at higher potential. Preferably, said potential difference is equal to at least 0.20 Volt, more preferably at least 0.50 Volt.

In each pair of metals between which said electron flow is generated, the metal which releases electrons acts as an anode and oxidizes, acting as a reducing agent, according to the half-reaction:

M→Mⁿ⁺+ne⁻ (2)

“n” being integer, preferably 2 or 3.

The metal which receives electrons acts instead as an inert cathode; at the cathode the H₃O⁺ ions present in the solution act as oxidizing agents and acquire electrons, according to the half-reaction:

2H⁺+2e⁻→H₂ (3)

In particularly on said at least one electrode the following oxide-reduction reaction occurs:

H₂O(I)→O₂(g)+2H₂(g) (4)

which leads to the formation of hydrogen gas along with oxygen.

The metal alloy forming said at least one electrode comprises preferably magnesium and at least one metal from among: beryllium (Be), aluminum (Al), manganese (Mn), zinc (Zn), iron (Fe), copper (Cu), silicon (Si), nickel (Ni).

In a preferred embodiment, said metal alloy comprises mainly magnesium. In a particularly preferred embodiment, said metal alloy contains an amount of magnesium in the range of 85% to 95%, preferably in the range of 90% to 91% by weight.

Magnesium is the metal with the lowest standard reduction potential of said plurality of metals, and therefore with the greatest tendency to transfer electrons. Therefore, when the metal alloy is in contact with the aqueous solution, a migration of electrons from the magnesium to each metal of said plurality of metals takes place. Magnesium, therefore, always acts as anode, oxidizing according to the half-reaction (1) in which n has the value 2.

Silicon is the metal with the highest standard reduction potential of said set of metals, so it always acts as an inert cathode, where the hydronium ions present in the solution acquire electrons forming hydrogen gas according to the half-reaction (2).

Each metal with an intermediate standard reduction potential between Mg and Si acts as an inert catode or as an anode oxidizing according to the half-reaction (1) depending on the metal with which the electron exchange takes place. When the half-reaction (1) involves metals such as Be, Mn, Zn, Fe, Cu and Ni, n assumes the value 2; when instead it involves metals such as Al, n assumes the value 3.

In a preferred embodiment of the invention, said metal alloy has the following percentage (%) by weight composition: 90.81% Mg; 5.83% Al; 2.85% Zn; 0.45% Mⁿ; 0.046% Si; 0.0036% Cu; 0.0012% Be; 0.0010% Fe; 0.00050% Ni.

According to another embodiment of the invention, said metal alloy has the following percentage (%) by weight composition: 90.65% Mg; 5.92% Al; 2.92% Zn; 0.46% Mn; 0.043% Si; 0.0036% Cu; 0.0012% Be; 0.0010% Fe; 0.00050% Ni.

According to a particularly advantageous embodiment of the invention, said at least one electrode is coated on its outer surface with a coating which comprises at least one metal fluoride, in particular a magnesium fluoride, aluminum fluoride and/or zinc fluoride.

Preferably said at least one electrode is coated externally with a coating comprising one or more of the aforementioned metal fluorides mixed with a methacrylic resin. Even more preferably said methacrylic resin comprises 50%-70% (by weight) PFTE, 15%-25% (by weight) 1,2-propanediol monomethacrylate (CAS.27813-02-1) and 15%-25% (by weight) hydroxyethyl methacrylate (CAS 868-77-9).

According to a preferred embodiment of the invention, said methacrylic resin comprises 60% (by weight) PFTE, 20% (by weight) 1,2-propanediol monomethacrylate (CAS.27813-02-1) and 20% (by weight) hydroxyethyl methacrylate (CAS 868-77-9).

Preferably, this coating of said at least one electrode has a thickness of 0.5 mm-3.0 mm, more preferably of 1.0 mm-2.0 mm.

According to a further preferred embodiment of the invention, said at least one electrode has at one of its ends a graphite element which is not covered by the aforementioned coating of the outer surface of the electrode.

Advantageously, a metal element is also provided inside said at least one electrode, such as an iron or carbon steel bar, this metal element being in contact with said graphite element of the electrode.

According to yet another embodiment of the invention, the outer coating of said at least one electrode is wrapped with a perforated tape or a PTFE mesh. Preferably, said tape or PTFE mesh applied onto the coating has a thickness of a few microns, for example 1-3 μm.

According to another embodiment of the invention, the outer coating of said at least one electrode is wrapped with a semi-permeable fabric tape, which is permeable to the passage of the aqueous solution towards the electrode and is impermeable to the aqueous solution in the opposite direction. Said fabric is also permeable to hydrogen.

The aforementioned aqueous solution is prepared by introducing hydrochloric acid into the water to form a mixture. Preferably, said mixture comprises hydrochloric acid in an amount ranging between 5 and 10%, preferably between 6 and 7%. Said percentage values are by volume.

The presence of hydrochloric acid in the aqueous solution causes the process of invention to take place in an acidic environment. The pH at which said process occurs is preferably in the range of 2 to 4, more preferably in the range of 2 to 3.4.

The process is carried out at a temperature preferably in the range of 20 to 70° C., preferably in the range of 55 to 60° C.

The process is preferably carried out at a pressure below atmospheric pressure, for example between 0.3 and 0.5 bar absolute.

The hydrogen thus obtained is released spontaneously from the solution, owing to its low molecular weight.

The oxygen generated during the process will remain instead in the aqueous solution, given its high molecular weight, and will tend to bond with the chlorine also present in the aqueous solution, to form hypochlorous acid (HCIO).

According to a preferred embodiment of the invention, in order to avoid a build-up of hypochlorous acid in the aqueous solution, the latter is advantageously regenerated by means of a recirculation step and a degassing step of the aqueous solution, adapted to extract the oxygen generated together with the hydrogen during the reduction step described above with reference to the half-reaction (3). Said degassing step comprises a filtration step during which the oxygen is removed.

In particular, the filtration step is performed using preferably porous baffle membrane filters charged with MnO₂, during which both oxygen (O₂) and chlorine (Cl₂) are released separately. The chlorine is then recovered by reintroducing it into the aqueous solution, preferably by bubbling.

Preferably, said degassing step is carried out under vacuum.

As the reactions forming the basis of the process according to the invention are exothermic, said recirculation step preferably also comprises a step of cooling the aqueous solution, adapted to keep the reaction temperature within the aforementioned range.

Another aspect of the invention concerns a plant for the production of hydrogen according to the process described above. This plant comprises:
at least one buffer tank for storing an aqueous solution containing hydrochloric acid in dissociated form;
at least one reactor for the production of hydrogen, in which at least one electrode composed of a metal alloy containing a plurality of metals with different standard reduction potentials is housed;
at least one feed line for supplying the aqueous solution from said at least one buffer tank to said at least one reactor;
at least one recirculation line for recirculation of the aqueous solution from said at least one reactor to said at least one buffer tank;
at least one device for regeneration of the aqueous solution, said device being positioned along said at least one recirculation line, and
means for extracting hydrogen gas from said at least one reactor.

Preferably, said regeneration device includes a filtering device containing for example at least one porous baffle membrane filter, preferably charged with MnO₂ adapted to separate the oxygen (O₂) which is formed during the production of hydrogen within said at least one reactor (degassing). Preferably said filtering device operates under vacuum.

Preferably, the plant according to the invention also comprises at least one cooling device along said recirculation line, comprising at least one heat exchanger adapted to cool the aqueous solution effluent from said at least one reactor and to keep the reaction temperature in the range of 20 to 70° C.

According to a particularly advantageous embodiment, said cooling device is arranged upstream of the regeneration device.

In some embodiments, the plant comprises two reactors in parallel, each with the respective feed and recirculation lines of the aqueous solution, the respective devices for regeneration of the aqueous solution circulating in the recirculation line and the respective hydrogen extraction means.

Another object of the invention concerns an electrode composed of a metal alloy for use in the hydrogen production process described above. With regard to the composition of the metal alloy from which the electrode is made and the actual structure of the electrode and its coating, reference may be made to the description provided in relation to the process.

An object of the invention is also an aqueous solution for use in the aforementioned hydrogen production process, containing hydronium ions (H₃O⁺) and chloride ions (Cl⁻).

A further object of the invention is a method for coating the outer surface of said at least one electrode.

Said method comprises:
a step involving dipping said at least one electrode in a hydrofluoric acid and water bath, in which the metals that make up the outer surface of the electrode react with the hydrofluoric acid to form a fluorinated patina of metal fluoride salts;
a first step of drying said fluorinated patina of metal fluoride salts;
a step of smearing a methacrylic resin gel on said fluorinated patina, said methacrylic resin being of the type described in relation to the process;
a second step of drying the mixture thus obtained comprising metal fluorides and methacrylic resin, in order to obtain an outer coating of said electrode.

Preferably, said second drying step has a duration of 10-16 hours, more preferably 12 hours.

According to a preferred embodiment of the invention, the method for coating the electrode furthermore involves, at the end of said second drying step, the step of wrapping the electrode with a perforated tape or a PTFE mesh.

Preferably, said tape or PTFE mesh has a thickness of a few microns, for example 1-3 μm.

According to another embodiment of the invention, said step of wrapping the electrode is performed with a semi-permeable fabric tape, which is permeable to the passage of the aqueous solution towards the electrode and is impermeable to the aqueous solution in the opposite direction. Said fabric is also permeable to hydrogen.

This invention has the advantage of providing a process for the production of large quantities of hydrogen with a reduced energy consumption, since the hydrogen is obtained substantially without external input of thermal and electrical energy; with a low environmental impact, since this process does not involve CO₂ emissions into the atmosphere; and at a low cost, since the hydrochloric acid is a commercial substance widely available on the market.

The advantages of the present invention will emerge even more clearly with the aid of the detailed description below, relating to a preferred embodiment, provided by way of a non-limiting example.

### BRIEF DESCRIPTION OF THE FIGURES

FIG. 1 shows a diagram of a plant for the production of hydrogen according to a preferred mode of implementation of the process according to the invention.

FIG. 2 shows in detail an electrode of the plant diagram according to FIG. 1.

### DETAILED DESCRIPTION OF A PREFERRED EMBODIMENT

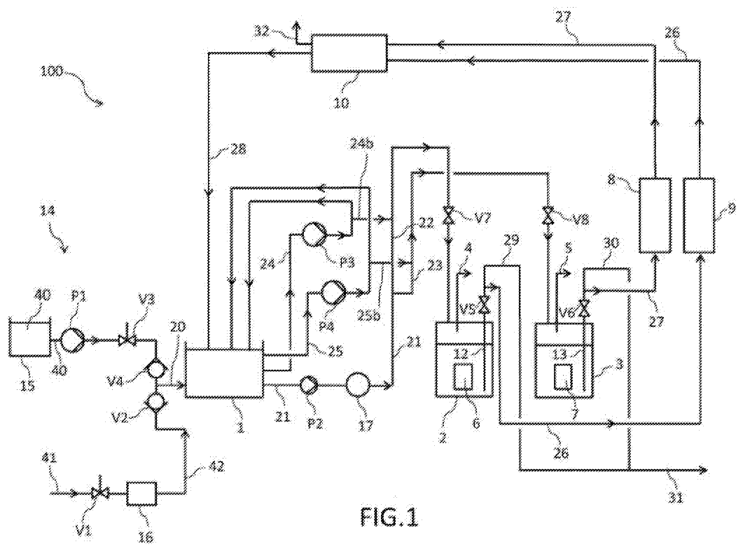

FIG. 1 shows a plant 100 for the continuous production of hydrogen. It essentially comprises a buffer tank 1 for the storage of an aqueous solution 20, two reactors 2 and 3 for the production of hydrogen, which are identical to each other and arranged in parallel, respective lines 21, 22 and 21, 23 for supplying the aqueous solution from the buffer tank 1 to the reactors 2 and 3, and means 4 and 5, for example conventional discharge pipes, for the extraction of the hydrogen gas produced in the aforementioned reactors 2 and 3.

Each reactor 2 and 3 contains a cartridge, indicated by the numbers 6 and 7 respectively, comprising a plurality of electrodes composed of metal alloys consisting of metals with different standard reduction potentials.

Said metal alloys include magnesium and at least one metal from among: beryllium (Be), aluminum (Al), manganese (Mn), zinc (Zn), iron (Fe), copper (Cu), silicon (Si), nickel (Ni). Preferably, magnesium is contained in an amount of 85% to 95%, more preferably 90 to 91% by weight.

Said electrodes are obtained from the aforementioned metals present in granular form, according to a process in which they are mixed and heated until they are completely melted and in which the molten mass thus obtained is cast into special molds inside which it is cooled and solidified. Finally, the electrodes according to the present invention are extracted from the molds.

According to a preferred embodiment of the invention, before casting the molten mass, a metal element, such as an iron or carbon steel bar, is arranged inside the molds. Preferably, the metal element is arranged inside the molds so that an end portion thereof does not come into contact with the molten mass. Once the molted mass has cooled and the electrodes have been extracted from the molds, the aforementioned end portion of the metal element will be located outside the electrodes and protruding from them.

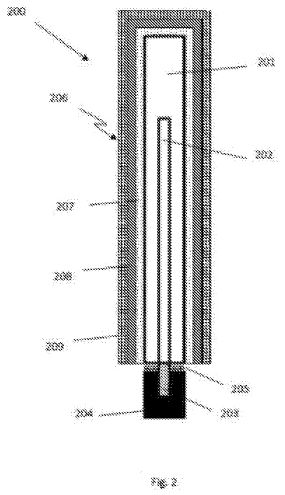

A preferred embodiment of the electrodes according to the present invention is shown in FIG. 2.

Said FIG. 2 shows schematically an electrode 200 comprising a substantially cylindrical body 201 consisting of said metal alloys and having a metal bar 202 housed therein. The bar 202 protrudes from the cylindrical body 201 at an end portion 203 thereof. Said end portion 203 has a graphite element 204 fixed thereto. Preferably, the graphite element is screwed onto the end portion of the bar 202 and a plastic washer 205 is placed between the graphite element 204 and the cylindrical body 201. A contact between the graphite element 203 and the bar 202 is thus formed.

The cylindrical body 201 in turn has an outer coating, generally indicated by 206 and comprising a layer 207 of at least one metal fluoride, in particular magnesium fluoride, aluminum fluoride and/or zinc fluoride, mixed with a methacrylic resin 208, preferably 60% (by weight) PFTE, 20% (by weight) 1,2-propanediol monomethacrylate (CAS.27813-02-1), and 20% (by weight) hydroxyethyl methacrylate (CAS 868-77-9).

The outer coating 206 composed of at least one metal fluoride and methacrylic resin is advantageously in turn covered by wrapping with a perforated tape or a PTFE mesh 209 having a thickness of a few microns, for example 1-3 μm.

In the example of FIG. 1, the electrodes, and cartridges 6 and 7 respectively, are arranged inside the reactors 2 and 3 in a raised position with respect to the bottom.

Each reactor 2, 3 is in fluid communication with the buffer tank 1 by means of respective lines 26, 28 and 27, 28 for recirculating the aqueous solution, which pass through a series of equipment for treating the said solution. In particular, each reactor 2, 3 is in fluid communication via the aforementioned recirculation lines with a cooling device 8, 9 consisting of at least one heat exchanger (not shown). From the cooling devices 8, 9 the aqueous solution flows into a filtering device 10 which comprises porous baffle membrane filters, preferably charged with MnO₂ (not shown), able to separate the oxygen (O₂) which is formed during hydrogen production within the reactors 2 and 3 (degassing).

Each recirculation line 26, 28, 27, 28 is connected with the inside of the reactors 2, 3 via special draw-off pipes 12 and 13, which extend substantially to the bottom of the said reactors. In particular, the opening of said draw-off pipes 12, 13 is located below the cartridge 6, 7 between the bottom of the reactor 2, 3 and the base of the cartridge itself.

The plant also has one or more lines for internal recirculation of the aqueous solution present in the buffer tank 1. Depending on the requirements, these lines can be connected to the lines for supplying the aqueous solution to the reactors, via respective connection ducts. In the example shown in FIG. 1, there are two internal recirculation lines 24 and 25 connected to the supply lines 22 and 23 via respective connection ducts 24b and 25b.

The plant also comprises a section 14 upstream of the buffer tank 1, in which the aqueous solution 20 is prepared by mixing an acid solution 40 of hydrochloric acid with mains water 41. Said section 14 essentially comprises a tank 15 for storing the acid solution 40, a device 16 for filtering the mains water and a line 42 for supplying the filtered water.

The flow 41 of mains water is controlled by a valve V1 upstream of the filtering device 16 and a non-return valve V2 downstream thereof. The solution 40 is instead pumped by a pneumatic pump P1 connected to the tank 15, which is activated upon filling of the buffer tank 1, opening a pneumatic valve V3. Then the solution 40 passes through a non-return valve V4 and is mixed with the filtered mains water 42, forming the aforementioned aqueous solution 20.

Said aqueous solution 20 preferably comprises hydrochloric acid in an amount of between 3 and 20% (vol) and between 5 and 10% (vol), preferably between 6 and 7% (vol).

During use, the plant 100 operates as follows:

The buffer tank 1 is filled with the aqueous solution 20. Said aqueous solution is then supplied to the reactors 2 and 3 until the respective liquid levels L1 and L2 are reached.

In more detail and with reference to the example shown in FIG. 1, the aqueous solution exiting the buffer tank 1 via line 21 is pumped by a pump P2, is conveyed through a flowmeter 17, which controls filling of the reactors 2 and 3, and is then divided into two portions, which supply, via the lines 22 and 23, the reactors 2 and 3, passing through respective pneumatic valves V6 and V7.

Once the reactors are filled, the aqueous solution remains inside them for a predetermined time, preferably in the region of a several minutes, and reacts in the presence of the electrodes to give hydrogen gas together with oxygen, according to the reaction (4): H₂O(I)→O₂ (g)+2H₂ (g). The reaction temperature is preferably between 55 and 60° C. and the pressure between 2.5 and 3 bar.

The hydrogen gas thus obtained, owing to its low molecular weight, is released from the solution and accumulates in a collection chamber inside the reactors 2, 3, said chamber being situated between the liquid levels L1, L2 and the lid of the respective reactors. The hydrogen accumulated in said chamber is extracted from the reactors 2 and 3 through the respective discharge pipes 4 and 5 and is stored in suitable tanks (not shown).

The aqueous solution is instead extracted via the respective draw-off pipes 12, 13 and recirculated within the recirculation lines 26, 27. The extraction of the aqueous solution is controlled by the pneumatic valves V5 and V6, the opening of which is controlled by the liquid levels L1 and L2 in the reactors 2, 3.

The position of the opening of the draw-off pipes 12, 13 below the cartridges 6, 7 is such that the hydrogen gas generated at the electrodes is not drawn together with the aqueous solution into the recirculation lines 26, 27.

The aqueous solution extracted from the reactors via the recirculation lines 26, 27 is first subjected to a cooling step in the heat exchangers of the cooling devices 8 and 9, by means of indirect heat exchange with a cooling water flow (not shown). The aqueous solution circulating in the recirculation lines 26, 27 is cooled so that a constant temperature, preferably of between 55-60° C., is maintained inside the reactors 2, 3.

The aqueous solution thus cooled is then subjected to a degassing step in order to extract the oxygen from the aqueous solution. This degassing step comprises a filtration step which is preferably carried out under a vacuum inside the filtering device 10. By so doing, the oxygen is separated from the aqueous solution and extracted via a special discharge pipe 32. The term under vacuum denotes a pressure slightly less than 1 bar, for example between 0.5 and 0.8 bar.

During the filtration step, which is carried out inside the device 10 using porous baffle membrane filters, preferably charged with MnO₂ (not shown), in addition to the oxygen also chlorine (Cl₂) is released separately. The latter is then recovered by reintroducing it into the aqueous solution, preferably by bubbling.

The aqueous solution which is essentially free of oxygen is then recirculated to buffer tank 1 via the recirculation line 28.

From the buffer tank 1, the aqueous solution 20 is reintroduced continuously into the reactors 2 and 3 via the supply lines 21, 22 and 21, 23, so as to keep the liquid levels L1 and L2 constant. Said aqueous solution 20 is kept in constant movement by recirculating it through internal recirculation lines 24 and 25. To allow recirculation, the aqueous solution is pumped by respective pumps P3 and P4.

During the operations involving checking or maintenance of the reactors 2 and 3, the latter are emptied via the respective channels 29 and 30 and the aqueous solution is sent to a waste collection tank (not shown) as a flow 31. During these operations, it is possible, if necessary, to carry out regeneration of the electrodes. In particular, it is possible to restore the outer coating 206 of the electrodes by immersing these electrodes in an aqueous solution with hydrofluoric acid for a suitable period of time, for example 10-20 minutes, preferably 15 minutes.

If required, during operation of the plant, a part of the aqueous solution circulating in the internal recirculation lines 24, 25 may be supplied to the reactors 2, 3 via the respective ducts 24b, 25b which connect the recirculation lines 24, 25 with the respective supply lines 22, 23.

The apparatus used in the plant is advantageously realized in a sealed manner, being preferably made of steel, and in addition to the filtering device 10, the buffer tank 1 also operates under vacuum. In this case the pressure inside the buffer tank 1 is between 0.03-0.08 bar. By so doing, the oxygen present in the aqueous solution does not come into contact with the outside air.

Below an example of implementation of the process according to the invention is described.

### EXAMPLE

Two identical cylindrical reactors with a height of 120 cm and a diameter of 30 cm were used.

In each reactor, a cartridge containing 32 electrodes, also cylindrical in shape, with a height of 40 cm and a diameter of 4 cm, and made of a metal alloy consisting of: 90.81% Mg; 5.83% Al; 2.85% Zn; 0.45% Mn; 0.046% Si; 0.0036% Cu; 0.0012% Be; 0.0010% Fe; 0.00050% Ni, was introduced.

The cartridge was arranged at a height of about 20 cm from the bottom of the reactor.

Each reactor was then filled with a total volume of 25 litres of a solution comprising water and hydrochloric acid.

The aforementioned solution was prepared by introducing 2.36 litres of a 38% hydrochloric acid solution into a quantity of mains water such as to fill the aforementioned volume of 25 liters.

Therefore, the composition of the solution in the reactor was as follows: 26.464 liters of water and 0.896 liters of hydrochloric acid

In other words, the mixture comprised 96.72% (vol) of mains water and 3.28% of hydrochloric acid.

The residence time of the solution was about 15 minutes and it was possible to produce hydrogen gas in an amount equal to 22 Nm³/h. With such a hydrogen production process, an energy consumption of less than 1.5 kWh was advantageously achieved.

According to a further embodiment, the process of the invention also comprises the provision of hydrofluoric acid (HF) in the aqueous solution (20) containing hydrochloric acid in dissociated form. Preferably, such hydrofluoric acid (HF) is added in an amount of 50-70 ml, most preferably 60 ml, every 10′000 ml of said aqueous solution.

In this connection, the aqueous solution for use in the process of the invention also comprises hydrofluoric acid (HF), in the amount as set forth above, in addition to hydronium ions (H₃O⁺) and chloride ions (Cl⁻). In such an aqueous solution the hydrofluoric acid undergoes ionic dissociation.

Particularly satisfactorily results in terms of production of hydrogen gas (H₂), with an increase up to 20% of the production, are advantageously obtained by hitting the electrode(s) with visible coherent light, in particular LED light.

1. A process for the production of hydrogen starting from an aqueous solution (20) containing hydrochloric acid in dissociated form, said solution containing hydronium ions (H₃O⁺), within said aqueous solution there being present an electrode composed of a metal alloy containing a plurality of metals with different standard reduction potentials,
the process comprising the following steps:
reducing the hydronium ions (H₃O) present in the solution to hydrogen gas (H₂), as a result of a flow of electrons generated in said at least one electrode between pairs of metals, from the metal having a lower potential to the metal having a higher potential, and
extracting the hydrogen gas from said aqueous solution.

2. The process according to claim 1, wherein said metal alloy comprises magnesium and a metal selected from the group consisting of: beryllium (Be), aluminum (Al), manganese (Mn), zinc (Zn), iron (Fe), copper (Cu), silicon (Si), and nickel (Ni).

3. The process according to claim 2, wherein said metal alloy comprises mainly magnesium.

4. The process according to claim 3, wherein said metal alloy contains an amount of magnesium in the range of 85% to 95% by weight, preferably 90% to 91% by weight.

5. The process according to claim 2,
wherein the metal alloy of said electrode is composed of:
A) 90.81% Mg; 5.83% Al; 2.85% Zn; 0.45% Mn; 0046% Si; 0.0036% Cu; 0.0012% Be; 0.0010% Fe; 0.00050% Ni, or
b) 90.65% Mg; 5.92% Al; 2.92% Zn; 0.46% Mn; 0043% Si; 0.0036% Cu; 0.0012% Be; 0.0010% Fe; 0.00050% Ni.

6. The process according to claim 1, wherein said electrode is coated on its outer surface with a coating which comprises a metal fluoride, said metal fluoride optionally being a magnesium fluoride, aluminum fluoride and/or zinc fluoride.

7. The process according to claim 6, wherein said coating comprises said metal fluoride mixed with a methacrylic resin.

8. The process according to claim 7, wherein said methacrylic resin comprises 50%-70% (by weight) PFTE, 15%-25% (by weight) 1,2-propanediol monomethacrylate (CAS.27813-02-1) and 15%-25% (by weight) hydroxyethyl methacrylate (CAS 868-77-9).

9. The process according to claim 8, wherein said methacrylic resin comprises 60% (by weight) PFTE, 20% (by weight) 1,2-propanediol monomethacrylate (CAS.27813-02-1) and 20% (by weight) hydroxyethyl methacrylate (CAS 868-77-9).

10. The process according to claim 6, wherein said coating of said electrode has a thickness of 0.5 mm-3.0 mm, or of 1.0 mm-2.0 mm.

11. The process according to claim 6, wherein said electrode has at one of its ends a graphite element, and wherein said coating of the outer surface of said electrode does not cover said graphite element.

12. The process according to claim 11, wherein a metal element is provided inside said electrode, optionally an iron or carbon steel bar, said metal element being in contact with said graphite element.

13. The process according to claim 6, wherein said outer coating is wrapped with a perforated tape or a PTFE mesh or with a semi-permeable fabric tape, which is permeable to the passage of the aqueous solution towards the electrode and is impermeable to the aqueous solution in the opposite direction.

14. The process according to claim 1, wherein said aqueous solution comprises hydrochloric acid in a concentration of 5 to 10%.

15. The process according to claim 1, wherein the pH of said aqueous solution is in the range of 2 to 4.

16. The process according to claim 1, wherein the reduction reaction of the hydronium ions to hydrogen gas occurs at a temperature of between 20 and 70° C., or between 55 and 60° C.

17. The process according to claim 1, wherein the reaction of reduction of the hydronium ions to hydrogen gas occurs at a pressure below atmospheric pressure.

18. The process according to claim 1, wherein said aqueous solution is regenerated by means of a recirculation step and a degassing step of the aqueous solution and said degassing step comprises a filtration step where oxygen is removed from the aqueous solution.

19. The process according to claim 18, wherein said filtration step is performed using porous baffle membrane filters, optionally charged with MnO₂, where both oxygen (O₂) and chlorine (Cl₂) are released separately.

20. The process according to claim 19, wherein the released chlorine is recovered and reintroduced into the aqueous solution, optionally by bubbling.

21. The process according to claim 18, wherein the recirculation step comprises a step of cooling the aqueous solution adapted to keep the reaction temperature substantially constant.

22. The process according to claim 1, also comprising the provision of hydrofluoric acid (HF) in the aqueous solution (20) containing hydrochloric acid in dissociated form.

23. The process according to claim 22, wherein said hydrofluoric acid (HF) is added in an amount of 50-70 ml, or 60 ml, for every 10,000 ml of said aqueous solution.

24. The process according to claim 1, wherein said process comprises hitting the electrode(s) with visible coherent light.

25. The process according to claim 24, wherein said process comprises hitting the electrode(s) with LED light.

26. A plant for the production of hydrogen in accordance with the process according to claim 1, said plant comprising:
a buffer tank for storing an aqueous solution containing hydrochloric acid in dissociated form;
a reactor for the production of hydrogen, inside which an electrode composed of a metal alloy containing a plurality of metals with different standard reduction potentials is housed;
a feed line for feeding of the aqueous solution from said buffer tank to said reactor;
a recirculation line for recirculation of the aqueous solution from said reactor to said buffer tank;
a device for regeneration of the aqueous solution, said device being positioned along said recirculation line, and
means for extracting hydrogen gas from said reactor.

27. The plant according to claim 26, wherein said regeneration device comprises a filtering device comprising a porous baffle membrane filter, optionally charged with MnO₂, able to separate oxygen (O₂) from said aqueous solution.

28. The plant according to claim 27, wherein said filtering device operates under vacuum.

29. The plant according to claim 26, further comprising a cooling device along said recirculation line.

30. An electrode for use in the hydrogen production process according to claim 1, composed of a metal alloy containing magnesium and a metal selected from the group consisting of: beryllium (Be), aluminum (Al), manganese (Mn), zinc (Zn), iron (Fe), copper (Cu), silicon (Si), and nickel (Ni).

31. The electrode according to claim 30, wherein said metal alloy contains an amount of magnesium in the range of 85% to 95% by weight, or 90% to 91% by weight.

32. The electrode according to claim 31, wherein said metal alloy is composed of
A) 90.81% Mg; 5.83% Al; 2.85% Zn; 0.45% Mn; 0046% Si; 0.0036% Cu; 0.0012% Be; 0.0010% Fe; 0.00050% Ni, or
b) 90.65% Mg; 5.92% Al; 2.92% Zn; 0.46% Mn; 0043% Si; 0.0036% Cu; 0.0012% Be; 0.0010% Fe; 0.00050% Ni.

33. The electrode according to claim 30, wherein said electrode is coated on its outer surface with a coating which comprises a metal fluoride, the metal fluoride optionally being a magnesium fluoride, aluminum fluoride and/or zinc fluoride.

34. The electrode according to claim 33, wherein said coating comprises said metal fluoride mixed with a methacrylic resin.

35. The electrode according to claim 34, wherein said methacrylic resin comprises 50%-70% (by weight) PFTE, 15%-25% (by weight) 1,2-propanediol monomethacrylate (CAS.27813-02-1) and 15%-25% (by weight) hydroxyethyl methacrylate (CAS 868-77-9).

36. The electrode according to claim 35, wherein said methacrylic resin comprises 60% (by weight) PFTE, 20% (by weight) 1,2-propanediol monomethacrylate (CAS.27813-02-1) and 20% (by weight) hydroxyethyl methacrylate (CAS 868-77-9).

37. The electrode according to claim 30, wherein said coating of said electrode has a thickness of 0.5 mm-3.0 mm, or of 1.0 mm-2.0 mm.

38. The electrode according to claim 30, wherein said electrode has at one of its ends a graphite element, and wherein said coating of the outer surface of said electrode does not cover said graphite element.

39. The electrode according to claim 38, wherein a metal element is provided inside said electrode, optionally the metal element being an iron or carbon steel bar, said metal element being in contact with said graphite element.

40. The electrode according to claim 33, wherein said outer coating is wrapped with a perforated tape or a PTFE mesh or with a semi-permeable fabric tape, which is permeable to the passage of the aqueous solution towards the electrode and is impermeable to the aqueous solution in the opposite direction.

41. (canceled)

42. (canceled)

43. (canceled)

44. A method for coating an electrode composed of a metal alloy containing a plurality of metals with different standard reduction potentials, said electrode being for use in the process for the production of hydrogen according to claim 1, the coating method comprising:
a) dipping the electrode in a hydrofluoric acid and water bath, in which the metals that make up the outer surface of the electrode react with the hydrofluoric acid to form a fluorinated patina of metal fluoride salts;
b) drying said fluorinated patina of metal fluoride salts;
c) smearing a methacrylic resin gel on said fluorinated patina; and
d) drying the mixture thus obtained comprising metal fluorides and methacrylic resin.

45. The method according to claim 44, wherein said methacrylic resin comprises 50%-70% (by weight) PFTE, 15%-25% (by weight) 1,2-propanediol monomethacrylate (CAS.27813-02-1) and 15%-25% (by weight) hydroxyethyl methacrylate (CAS 868-77-9).

46. The method according to claim 44, wherein at the end of said second drying step, said electrode is wrapped with a perforated tape or a PTFE mesh or with a semi-permeable fabric tape, which is permeable to the passage of the aqueous solution towards the electrode and is impermeable to the aqueous solution in the opposite direction.
